(19) United States
(12) Patent Application Publication
(10) Pub. No.: US 2024/0149970 A1
(43) Pub. Date: May 9, 2024

(54) VIBRATION DAMPER, BICYCLE FORK, SPRING STRUT, AND USE OF A VIBRATION DAMPER

(71) Applicants: thyssenkrupp Bilstein GmbH, Ennepetal (DE); thyssenkrupp AG, Essen (DE)

(72) Inventors: Michael HEYER, Wetter (DE); Hanno LUCZAK, Hattingen (DE); Dennis GUNDLACH, Witten (DE); Daniel HANSEN, Bochum (DE)

(73) Assignees: thyssenkrupp Bilstein GmbH, Ennepetal (DE); thyssenkrupp AG, Essen (DE)

(21) Appl. No.: 18/384,793

(22) Filed: Oct. 27, 2023

(30) Foreign Application Priority Data
Nov. 7, 2022 (DE) 10 2022 129 375.0

(51) Int. Cl. B62K 21/02

(52) U.S. Cl. CPC B62K 21/02

(57) ABSTRACT

A vibration damper with amplitude-dependent damping, with a cylindrical compensation space attached fluidically, in parallel to the vibration damper and is split by way of a displaceable separating piston, the vibration damper comprising a working piston, the working piston being received displaceably in a damper tube, the working piston dividing the damper tube into a first damping space and a second damping space, the separating piston being received axially displaceably in the compensation space, the separating piston dividing the compensation space into a first part space and a second part space, the first part space being connected fluidically to the first damping space, the second part space being connected fluidically to the damping space, the vibration damper being equipped with a throttle device for influencing the fluid flow between the first part space and the first damping space and/or between the second part space and the second damping space.

### CROSS REFERENCE TO RELATED APPLICATION

This application is a U.S. Non-Provisional that claims priority to German Patent Application No. DE 10 2022 129 375.0, filed Nov. 7, 2022, and the entire content of which is incorporated herein by reference.

### FIELD

The present disclosure relates to a vibration damper, and more specifically to a vibration damper equipped with amplitude-dependent damping.

### BACKGROUND

A vibration damper of the abovementioned type has been disclosed, for example, by EP 1 152 166 A1 and DE 103 51 353 B4. Here, a vibration damper is described with amplitude-dependent damping, in particular of a vehicle wheel, with a cylindrical compensation space which is attached fluidically, in particular hydraulically, in parallel to the vibration damper and is divided by way of an axially displaceable separating piston.

The vibration damper has a small spread of the characteristic curve in the damping system. Decoupling between a comfort characteristic curve and a hard characteristic curve is not possible, nor adjustability of the comfort-relevant range.

A passive vibration damper of this type as a rule has a defined (or variable in conjunction with adjustable valves) damping property (also called characteristic curve). The use of a cylindrical compensation space which is connected in parallel with a floating piston provides a stroke-dependent, non-variable second damper characteristic curve which denotes a parallel connection of two characteristic curves over a defined stroke. The vibration damper has a small spread of the characteristic curve in the damping system. Decoupling between a comfort characteristic curve and a hard characteristic curve is not possible, nor adjustability of the comfort-relevant range.

Although a usable vibration damper is already described here, there is nevertheless a need for improvement.

Thus a need exists for an improved vibration damper, in particular of proposing a vibration damper which can stop or at least decrease the problems outlined above. In particular, it is an object of the present disclosure to propose a vibration damper which can have a more advantageous spread of the characteristic curve in the damping system and/or by way of which decoupling between a comfort characteristic curve and a hard characteristic curve is possible.

By virtue of the fact that the vibration damper is equipped with a throttle device for influencing the fluid flow between the first part space and the first damping space and/or between the second part space and the second damping space, an improved vibration damper can be proposed. In particular, an improvement can be achieved with regard to the spread of the characteristic curve in the damping system and/or decoupling between a comfort characteristic curve and a hard characteristic curve. In other words, one essential concept of the present disclosure lies in making an infinitely variable adjustability as far as complete switching off of the parallel path possible. The spread is improved, in particular, by the adjustable amplitude-selective characteristic which lies in parallel.

### BRIEF DESCRIPTION OF THE FIGURES

Further advantageous details, features and details of the disclosure will be explained in more detail in the context of the exemplary embodiments illustrated in the figures, in which:

FIG. 1 shows a section through a vibration damper according to the disclosure in the region of the working piston.

FIG. 2 shows a detailed illustration of one embodiment of a vibration damper according to the disclosure in a sectioned side view.

FIG. 3 shows a bicycle fork in a perspective illustration.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

In one advantageous refinement of the disclosure, it can be provided that the throttle device is configured as a throttle slide. A throttle slide is a satisfactorily controllable component which is advantageously suitable for the envisaged purpose. In particular, only a small fault susceptibility and a high reliability are to be expected, even for an envisaged long-term use. A throttle slide is thus fundamentally configured to allow the fluid flow through in an unimpeded manner, to throttle it or to completely prevent it, which makes corresponding control of the fluid flow between the first part space and the first damping space and/or between the second part space and the second damping space possible in the present case here.

It can be provided in a further advantageous refinement of the disclosure that the throttle device comprises a passage opening, a slide and an actuating means of the slide. The throttle device or the throttle slide can fundamentally comprise standard components such as, for example, a passage opening for the fluid, a slide and an actuating means.

It can be provided in a further advantageous refinement of the disclosure that the slide has a hemispherical tip. By way of the contour, an envisaged flow behaviour of the fluid out of or into the passage opening can further advantageously be influenced, and/or the throughflow can be set.

It can be provided in a further advantageous refinement of the disclosure that the actuating means comprises a spindle drive with a handle, the spindle drive comprising a threaded spindle and a thread. The embodiment of the actuating means in the abovementioned way is robust and can advantageously be operated by a user.

It can be provided in a further advantageous refinement of the disclosure that the actuating means is configured as an electromechanical, hydraulic or pneumatic actuating means. The abovementioned possibilities are alternative actuating means which come into question primarily for an automated or remote-controllable use. The abovementioned actuating means can thus be part of an electronically controlled damping system.

By virtue of the fact that the bicycle fork comprises a vibration damper according to the disclosure, the advantages outlined above of the vibration damper can be made usable for the bicycle fork or for a bicycle which is equipped with a bicycle fork of this type, in particular a mountain bike.

It can be provided in one advantageous refinement of the disclosure that the bicycle fork comprises two fork legs, the fork leg comprising a vibration damper according to at least one of the preceding claims and a further damper tube, the damper tube being configured to dip into the further damper tube.

By virtue of the fact that the spring strut comprises a spring and a vibration damper according to the disclosure, the advantages outlined above of the vibration damper can be made usable for the spring strut and for a vehicle which is equipped with a spring strut of this type.

An advantageous use of the vibration damper results, in particular, as a vibration damper in a motor vehicle, motorcycle or cycle, preferably a mountain bike.

It goes without saying here that features and details which are described in conjunction with a method also apply in conjunction with the apparatus according to the disclosure, and vice versa, with the result that reference is always made or can always be made mutually with regard to the disclosure in respect of the individual aspects of the disclosure. Moreover, a method according to the disclosure which is possibly described can be carried out by way of the apparatus according to the disclosure.

The terminology used herein serves only for the purpose of the description of certain embodiments, and is not intended to restrict the disclosure. As used herein, the singular forms “a/an” and “the” are intended to also contain the plural forms as long as the context does not make it possible for this to be clearly perceived in some other way. In addition, it will be clear that the terms “has” and/or “having”, if used in this description, specify the presence of the indicated features, integers, steps, operations, elements and/or components, but do not preclude the presence or the addition of one or a plurality of other features, integers, steps, operations, elements, components and/or groups thereof. As used herein, the term “and/or” contains any desired element and all combinations of one or more of the associated, listed elements.

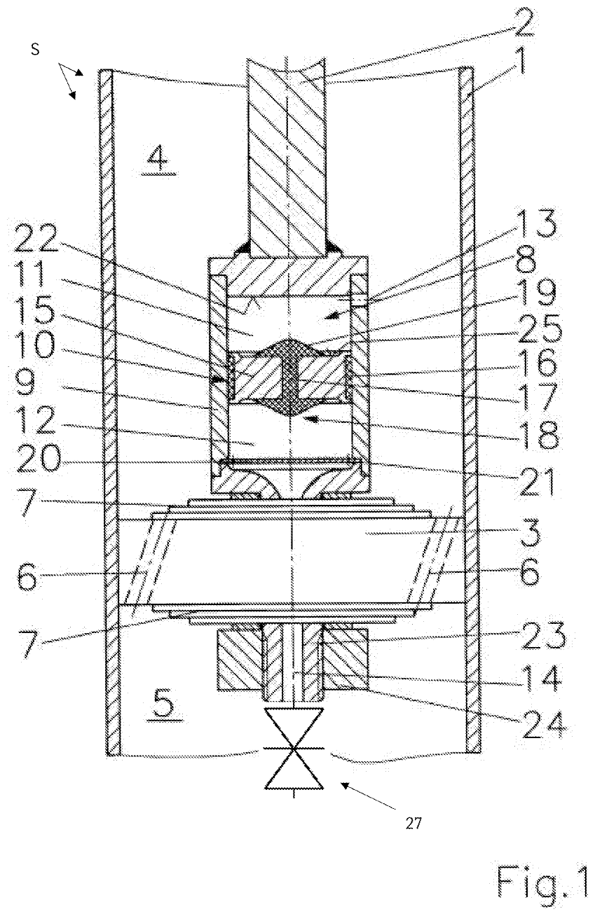

FIG. 1 shows a section through a vibration damper in the region of the damper piston. This is a monotube vibration damper. A longitudinal axis L is illustrated which runs in the axial direction. A damper tube 1 which is closed at the top and at the bottom is filled with damping liquid. Sealed on one side, a piston rod 2 dips into the damper tube 1 in an oscillating manner. The damper tube 1 and the piston rod 2 are connected by way of attachments (not shown) to the vehicle wheel and the body of a vehicle. A working piston 3 is attached (indirectly in the exemplary embodiment) to that end of the piston rod 2 which dips into the damper tube 1, which working piston 3 divides the interior space of the damper tube 1 into two damping spaces, in particular a first damping space 4 and a second damping space 5. Via passage ducts 6 which are each resiliently covered on one side by way of disc spring assemblies 7, the damping liquid can flow from one damping space 4, 5 into the other damping space 5, 4, the respective disc spring assembly 7 ensuring damping of this flow.

In the case of oscillations between the piston rod 2 and the damper tube 1 with a low amplitude, the problem arises that only small damping forces are required here, in order not to unnecessarily impair the driving comfort, but the damping force characteristic of the main valves which are used with disc spring plating does not make corresponding tuning possible, without at the same time decreasing the damping force even in the range of large excitation amplitudes, which would have a negative influence on the driving dynamics and driving safety. Therefore, a cylindrical compensation space 8 is accommodated in a piston rod extension 9 fluidically parallel to the working piston 3. The compensation space 8 is divided by means of a separating piston 10 into two part spaces, in particular a first part space 11 and a second part space 12. These part spaces 11, 12 are connected fluidically, in particular hydraulically, to in each case one damping space 4, 5, in each case via passage openings, preferably bores 13, 14.

In particular, the first part space 11 is connected fluidically, in particular hydraulically, via the passage opening 13 to the first damping space 4. Further preferably, the second part space 12 is connected fluidically, in particular hydraulically, via the passage opening 14 to the second damping space 5.

In other words, a compensation space 8 with a separating piston 10 is proposed here, which compensation space 8 is connected in parallel to the shock absorber fluidically, in particular hydraulically, to the upper and/or lower damping space 4 and/or 5. The spatial regions produced by way of the separating piston 10 are designed in such a way that the hydraulic medium of the associated damping space can flow into them. It is therefore then possible that the respective compensation space 8 which is divided by way of the separating piston can act outside the working piston as a compensation space for small shock absorber movements. The respective compensation space (divided spatial region) can be filled from the top or from the bottom with hydraulic oil without substantial damping, until the membrane or the displaceable fixed disc bears against one of the two walls of the respective spatial region which lie opposite one another and are preferably of curved configuration. A relatively undamped movement in the range of small amplitudes is achieved by way of this measure. The actual damping starts only after these small travels are exhausted. With regard to further details in respect of the functional principle, reference can be made to the comments made in this regard in EP 1 152 166 A1 and DE 103 51 353 B4.

The separating piston 10 can have a piston main body 15 which bears via a radially outer sliding cuff 16 radially against the cylinder inner wall of the compensation space 8, as a result of which the separating piston 10 is axially easily displaceable in the compensation space 8.

Furthermore, the separating piston 10 can have an axial penetration 17 which is configured as a central bore in the exemplary embodiment. A buffer 18 is inserted into this axial penetration 17. The buffer 18 protrudes beyond the two cover surfaces of the piston main body 15 with a central bulge 19. In FIG. 1, this central bulge 19 is provided on both sides on the separating piston 10 and is of approximately conical configuration. In FIG. 1, furthermore, the buffer is vulcanized or moulded with its web which penetrates the axial penetration 17 and its two central bulges 19 in one piece into or onto the piston main body 15.

The bore 14 which connects the lower part space 12 of the compensation space 8 to the lower damping space 5 is preferably routed as a central axial bore through the piston rod extension 9. This would have the consequence that, when the separating piston 10 comes into contact with the lower (according to FIG. 1) bottom of the compensation space 8, sudden closure of the bore 14 would take place, as a result of which shocks would be induced in the entire system which are not desired, and the stop buffer would be rapidly destroyed at the bore edge. Therefore, the central bore 14 is preferably covered by means of a separating disc 20 on the compensation space side. A plurality of penetrations 21 are provided, in particular, at the edge of the separating disc 20 for the inflow of the damping liquid from the bore 14 into the lower part space 12 of the compensation space 8. Therefore, soft contact of the separating piston 10 with that bottom of the compensation space 8 which is configured here as a separating disc 20 is also ensured in the case of the construction according to FIG. 1. With regard to the upper bottom 22 in FIG. 1, this is already ensured, in particular, by the radially outwardly directed bore 13. As an alternative, the separating disc 20 can be dispensed with if the bore 14 is configured by way of the receiving pin 23 as a blind bore and does not penetrate the lower bottom. The blind bore is then connected via one or more additional ducts to the part space 12. Here, the duct openings lie radially on the outside on the lower bottom, with the result that the buffer 18 cannot shut off the openings and is not destroyed by the opening edge.

The piston rod extension 9 which receives the compensation space 8 is preferably provided as a welded construction in FIG. 1. Towards the end, it has a receiving pin 23, on which the working piston 3 is fastened by way of a screw connection with a nut 24.

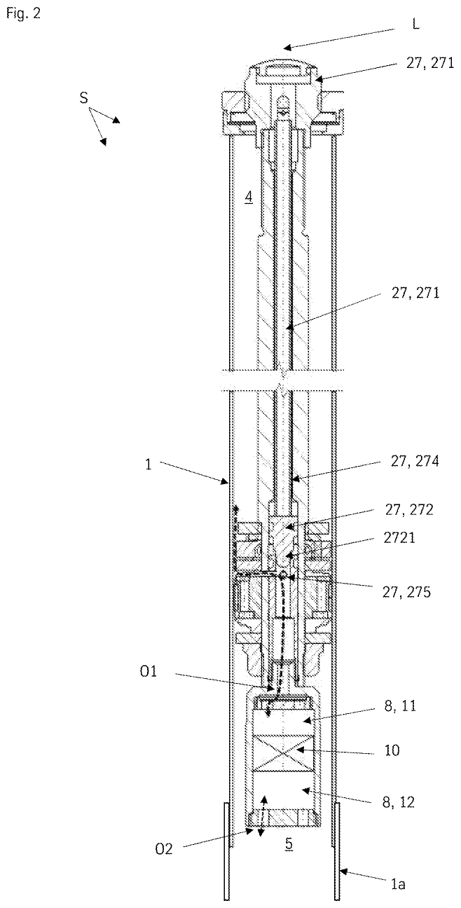

It is provided according to the disclosure that the vibration damper is equipped with a throttle device 27 for influencing the fluid flow between the second part space 12 and the second damping space 5 and/or between the first part space 11 and the first damping space 4. The throttle device 27 is fundamentally configured to allow through the fluid flow in an unimpeded manner, to throttle it or to completely prevent it. FIG. 1 shows one embodiment with a throttle device 27 for influencing the fluid flow between the second part space 12 and the second damping space 5. FIG. 2 shows one embodiment with a throttle device 27 for influencing the fluid flow between the first part space 11 and the first damping space 4.

The throttle device is preferably configured as a shut-off throttle, comprising a passage opening 275, a slide 272 and an actuating means for the slide 272. The actuating means can comprise, for example, a spindle drive with a handle 271. The spindle drive can comprise a threaded spindle 273 and a thread 274. An embodiment of this type is shown in FIG. 2.

FIG. 2 shows the throttle device in a completely open position. The fluid can flow between the first part space 11 and the first damping space 4 in an unimpeded manner, apart from the customary line losses. Here, the flow path runs through the passage opening 275.

As soon as the slide 272 partially closes the passage opening 275, the fluid flow is throttled. The slide 272 can also completely close the passage opening 275, with the result that the fluid flow on this path can no longer flow between the part space 12 and the damping space 5. The slide 272 can be displaced via the spindle drive which can in turn be actuated by a user by way of the handle 271. Other possibilities of actuation are of course also conceivable, for example electromechanically, hydraulically, pneumatically, etc. As provided here, the actuation can be manual, but can also be part of an autonomous vibration damper regulating system.

The oil flow from the damping space 4 to the part space 11 is shown by way of the dash-dotted line O1, and the oil flow from the damping space 5 to the part space 12 is shown for illustrative purposes by way of the dash-dotted line O2.

The slide 272 can be equipped with a tip 2721 which has a hemispherical contour. By way of the contour, an envisaged flow behaviour of the fluid out of or into the passage opening 275 can be influenced further. Influencing of the flow behaviour by way of the contour does not take place, however, in the case of a completely closed or completely open passage opening 275.

In the case of the exemplary embodiment which is shown in FIG. 2, the vibration damper according to the disclosure is part of a front wheel fork, in particular of a fork leg G, of a bicycle, preferably of a mountain bike. Numerous possible uses of the vibration damper S are conceivable, for example in the chassis of a motor vehicle, a motorcycle, etc. The vibration damper can be part of a spring strut, etc.

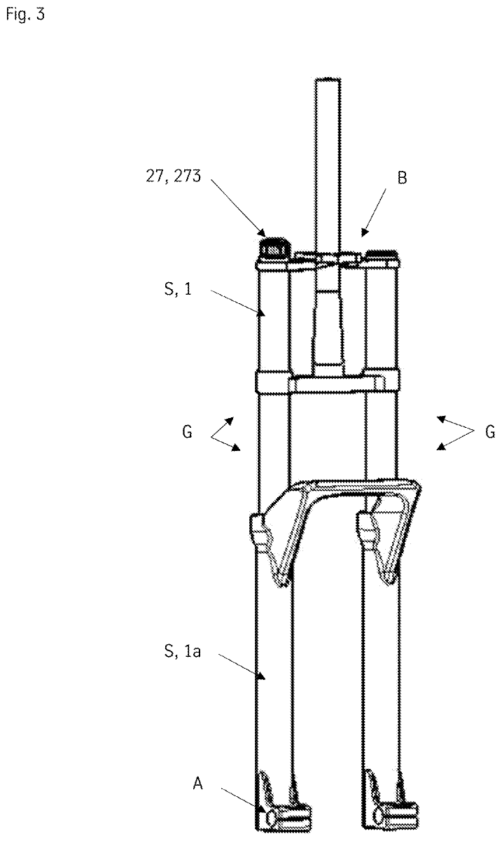

FIG. 3 depicts a perspective illustration of a front wheel fork, comprising two fork legs G and a top yoke B, of a bicycle. Here, the damper tube 1 forms a fork leg G together with a further damper tube 1a. The damper tube 1 can dip into the further damper tube 1a and be pulled out of it again. It goes without saying that the fork and/or the fork leg G can comprise further components. The illustration which is selected here is merely in principle. Ultimately, the principle of the throttle device 27 is also implemented here in order to influence the fluid flow between the part space 12 and the damping space 5 and/or between the part space 11 and the damping space 4. Correspondingly, the fork leg G or the vibration damper S according to the disclosure which is integrated into the fork leg can have the advantages already outlined above. An axle connector A for the front wheel axle (not shown) is provided at the end of the further damper tube 1a. A top yoke B engages around the damper tube 1 and/or connects the two fork legs.

Oil is possible as damping fluid, with which the respective part spaces and damping spaces are filled. However, other suitable fluids are also conceivable.

The following reference signs are used in the drawings:
L Longitudinal axis
S Vibration damper
O1 Oil flow (damping fluid)
O2 Oil flow (damping fluid)
G Fork leg
A Axle connector
B Top yoke
1 Damper tube
2 Piston rod
3 Working piston
4 (First) damping space
5 (Second) damping space
6 Passage duct
7 Disc spring assembly
8 Compensation space
9 Piston rod extension
10 Separating piston
11 (First) part space
12 (Second) part space
13 Bore
14 Bore
15 Piston main body
16 Sliding cuff
17 Axial penetration
18 Buffer
19 Central bulge
20 Separating disc
21 Penetration
22 Bottom
23 Receiving pin
24 Nut
25 Cover surface
27 Throttle device
271 Handle
272 Slide
273 Threaded spindle
274 Thread
275 Passage opening
2721 Tip

What is claimed is:

1. A vibration damper with amplitude-dependent damping with a cylindrical compensation space which is attached fluidically, in particular hydraulically, in parallel to the vibration damper and is split by way of a displaceable separating piston, the vibration damper comprising:
a working piston, the working piston being received displaceably in a damper tube, the working piston dividing the damper tube into a first damping space and a second damping space, the separating piston being received axially displaceably in the compensation space, the separating piston dividing the compensation space into a first part space and a second part space, the first part space being connected fluidically to the first damping space, the second part space being connected fluidically to the second damping space, wherein the vibration damper includes a throttle device configured for influencing fluid flow between the first part space and the first damping space and/or between the second part space and the second damping space.

2. The vibration damper of claim 1, wherein the throttle device is configured as a throttle slide.

3. The vibration damper of claim 1, wherein the throttle device comprises a passage opening, a slide and an actuating means for the slide.

4. The vibration damper of claim 1, wherein the slide comprises a hemispherical tip.

5. The vibration damper of claim 1, wherein the actuating means comprises a spindle drive with a handle, the spindle drive comprising a threaded spindle and a thread.

6. The vibration damper of claim 1, wherein the actuating means is configured as an electromechanical, hydraulic or pneumatic actuating means.

7. A bicycle fork comprising:
a vibration damper (S) of claim 1.

8. The bicycle fork of claim 7, comprising two fork legs (G), the fork leg comprising a vibration damper (S) according to at least one of the preceding claims and a further damper tube (1a), the damper tube of the vibration damper being configured to dip into the further damper tube (1a).

9. A method of using of the vibration damper (S) of claim 1, as a vibration damper on a motor vehicle, motorcycle or bicycle.
